(19) United States
(12) Patent Application Publication
(10) Pub. No.: US 2022/0255840 A1
(43) Pub. Date: Aug. 11, 2022

(54) ROUTE CONTROL DEVICE, ROUTE CONTROL METHOD, PROGRAM, AND NETWORK SYSTEM

(71) Applicant: Nippon Telegraph and Telephone Corporation, Tokyo (JP)

(72) Inventors: Hiroki MORI, Musashino-shi, Tokyo (JP); Satoshi NAKATSUKASA, Musashino-shi, Tokyo (JP); Ken TAKAHASHI, Musashino-shi, Tokyo (JP)

(21) Appl. No.: 17/623,558

(22) PCT Filed: Jul. 1, 2019
(86) PCT No.: PCT/JP2019/026046

§ 371 Date: Dec. 28, 2021

(51) Int. Cl. H04L 45/121; H04L 45/02

(52) U.S. Cl. CPC H04L 45/121; H04L 45/02

(57) ABSTRACT

A routing control device (1) includes: a configuration management unit (11) configured to generate NW configuration information (t1) that indicates a configuration of a communication network via which predetermined services are provided; a calculation unit (12) configured to calculate, based on the NW configuration information (t1), routes that have a minimum transmission delay between nodes disposed in the communication network; and a setting unit (13) configured to set a calculated route for a low latency service that requires an allowable value of transmission delay to be less than or equal to a predetermined value, out of the services.

### TECHNICAL FIELD

The present invention relates to a routing control device, a routing control method, a program, and a network system.

In the present description, a network is sometimes denoted as “NW”.

### BACKGROUND ART

In a communication network that requires low latency as represented by 5G (fifth generation mobile communication systems), it is necessary to select a route in the communication network that makes transmission delay as small as possible, that is, a route that has a short transmission distance.

For example, in OSPF (Open Shortest Path First) for use in routing control in communication networks, a route is selected such that the sum of link costs set for links on the route is minimum. Accordingly, if OSPF is followed, a route that has the minimum transmission distance cannot necessarily be selected. At this time, if the link costs are set to values that are proportional to transmission distances, it will be possible to select the shortest route having the minimum transmission distance only using OSPF. However, in actual network operations, the link costs are set taking into consideration the priorities and redundant configuration of the links. Therefore, it is difficult to set the link costs to values that are proportional to transmission distances. Also, the state of delay in the communication network is not constant, and may change with time. Accordingly, in routing control based on link costs fixedly set to values proportional to transmission distances, it is not always the case where a route that has the minimum delay is selected. As a result, this may adversely affect services.

Also, a method has been proposed in which routing control is performed using Openflow, which enables routing control for each flow unit, so that delay is minimized according to the state of a network (see NPL 1). However, in this method, it is necessary to control routing for every flow, and thus the loads in route computation and control increase. As a result, it is difficult to apply the routing control using Openflow to a particularly large-scale network.

### CITATION LIST

### Non Patent Literature

[NPL 1] Uppal, Hardeep, and Dane Brandon “Openflow based load balancing” CSE561: Networking Project Report, University of Washington (2010).

### SUMMARY OF THE INVENTION

### Technical Problem

In view of such circumstances, an object of the present invention is to realize routing control that reduces transmission delay in a communication network, and reduces the computational load.

### Means for Solving the Problem

In order to solve the aforementioned problem, the present invention relates to a routing control device that controls routing on a communication network via which predetermined services are provided, the routing control device including: a configuration management unit configured to generate NW configuration information that indicates a configuration of the communication network; a calculation unit configured to calculate, based on the NW configuration information, routes that have a minimum transmission delay between nodes disposed in the communication network; and a setting unit configured to set a calculated route for a low latency service that requires an allowable value of transmission delay to be less than or equal to a predetermined value, out of the services.

### Effects of the Invention

According to the present invention, it is possible to realize routing control that reduces transmission delay in a communication network, and reduces the computational load.

### BRIEF DESCRIPTION OF DRAWINGS

FIG. 1 is a functional configuration diagram illustrating an example of a routing control device according to the present embodiment.

FIG. 2 is a flowchart illustrating processing regarding initial route setting.

FIG. 3 is a flowchart illustrating processing regarding route setting that is performed when the configuration of a communication network has been changed.

FIG. 4 is a diagram illustrating NW configuration information, service information, shortest route information, and communication route information in a specific example of the initial route setting.

FIG. 5 is a diagram illustrating a communication network for which the initial route setting has been performed.

FIG. 6 is a diagram illustrating NW configuration information, communication route information, shortest route information, possibly changed route information, shortest route renewal information, differential route information, updated communication route information, and updated shortest route information, in a specific example of the route setting when the configuration of a communication network is changed.

FIG. 7 is a diagram illustrating a communication network for which the route setting has been performed when the configuration of a communication network was changed.

FIG. 8 is a hardware configuration diagram illustrating an example of a computer that realizes the functions of the routing control device.

### DESCRIPTION OF EMBODIMENTS

The following will describe the mode for implementing the present invention (hereinafter, referred to as the “present embodiment”) with reference to the drawings.

<Configuration>

A routing control device according to the present embodiment is a computing machinery that controls routing on a communication network via which predetermined services are provided. The communication network includes a plurality of nodes, and links that connect the nodes. The nodes and the links may be physical or virtual. Note that a network system is configured that includes the routing control device and the communication network.

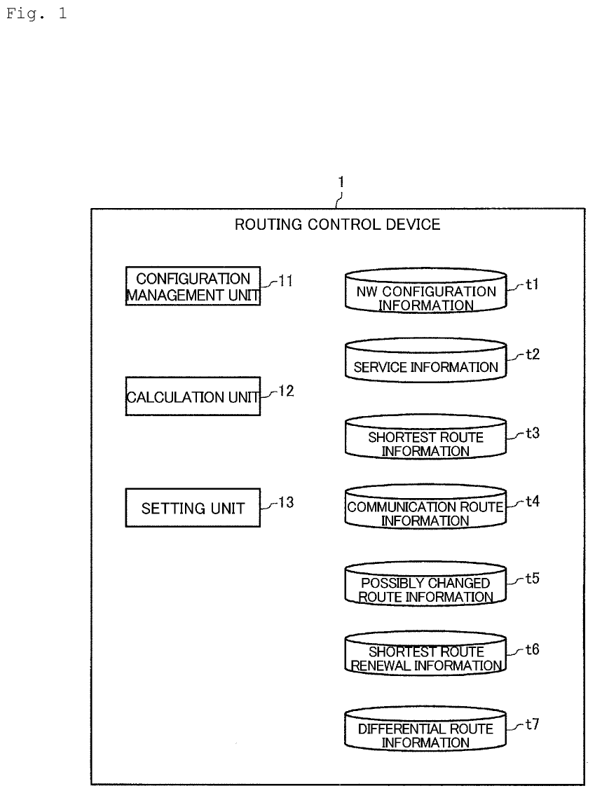

As shown in FIG. 1, a routing control device 1 according to the present embodiment includes functional units such as a configuration management unit 11, a calculation unit 12, and a setting unit 13. Also, the routing control device 1 of the present embodiment stores information such as NW configuration information t1, service information t2, shortest route information t3, communication route information t4, possibly changed route information t5, shortest route renewal information t6, and differential route information t7.

The configuration management unit 11 acquires information from the communication network, specifically, the nodes disposed in the communication network. The acquired information is, for example, topological information indicating the topology of the communication network, and delay information indicating a transmission delay value or a transmission distance, but is not limited to them. The topological information is, for example, neighbor information of LLDP (Link Layer Discovery Protocol) or neighbor information of OSPF, but is not limited to them. The delay information is, for example, information obtained when an inspection packet (such as, e. g., ping and DM (Delay Measurement)) is transmitted between the nodes and measurement is performed. The configuration management unit 11 generates the NW configuration information t1 based on the information acquired from the communication network.

If the configuration of the communication network is changed, the configuration management unit 11 updates the NW configuration information t1. Examples of the reason for the change in the configuration of the communication network include a transmission delay change, an addition of a link, a deletion of a link, and a node or link failure, but the reason is not limited to them. If a node failure is regarded as a failure of a link connected to this node, the failure can be unified into the link failure.

The calculation unit 12 calculates, based on the NW configuration information t1, routes that have the minimum transmission delay between the nodes. The calculation unit 12 generates the calculated routes as the shortest route information t3.

If the configuration of the communication network is changed, the calculation unit 12 extracts, based on the updated NW configuration information t1 and the generated shortest route information t3, a possibly changed route, which is a route that may be changed, out of the routes indicated by the shortest route information t3. Note that extraction conditions for extracting a possibly changed route will be described later. The calculation unit 12 generates the possibly changed route information t5 that indicates the extracted possibly changed route. Also, the calculation unit 12 recalculates the extracted route serving as the possibly changed route to obtain a route having a minimum transmission delay. The calculation unit 12 generates the recalculated route as the shortest route renewal information t6.

Note that the extraction conditions for the calculation unit 12 extracting a route serving as the possibly changed route mainly include following extraction conditions [1] to [3], but are not limited to them.

The extraction condition [1]: if a link is added as a change in the configuration of the communication network, a route that has a value larger than the transmission delay value of the added link will be extracted (namely, if the transmission delay value of the added link is 10 ms, a route that has a transmission delay value larger than 10 ms will be extracted).

The extraction condition [2]: if the transmission delay value of a specific route is increased as a change in the configuration of the communication network, a route that includes a link having an increased transmission delay will be extracted. A failed or deleted link also corresponds to the “link having an increased transmission delay” (because it is dealt with as a transmission delay value ∞). It is also possible to extract a route that has a current transmission delay value larger than the value before the configuration is changed (if the transmission delay value of a specific route is changed from 30 ms to 40 ms, a route that has a transmission delay value larger than 30 ms will be extracted as a possibly changed route).

The extraction condition [3]: if a transmission delay value of a specific route is decreased as a change in the configuration of the communication network, a route that has a current transmission delay value larger than the value after the configuration is changed will be extracted (if the transmission delay value of a specific route is changed from 30 ms to 20 ms, a route that has a transmission delay value larger than 20 ms will be extracted as a possibly changed route). Alternatively, it is possible to extract a route that does not include a link having a decreased transmission delay in the current shortest route.

In view of the extraction conditions [1] to [3], the “route that may be changed, out of the routes indicated by the shortest route information t3”, which serves as possibly changed routes, can be said as a route whose transmission delay is changed due to a change in the configuration of the communication network.

The setting unit 13 sets, based on the service information t2 and the shortest route information t3, the routes calculated by the calculation unit 12 for the nodes disposed in the communication network (route setting). The route setting is performed for each service. Here, a configuration is also possible in which a maintainer terminal gives an instruction to perform route setting, and the calculation unit 12 performs route setting in response to this instruction.

Note that route setting itself with respect to nodes is well-known, and thus detailed description is omitted. Also, the setting unit 13 generates the routes set for the nodes as the communication route information t4. The communication route information t4 is generated for each service.

If the configuration of the communication network is changed, the setting unit 13 compares the shortest route renewal information t6 with the communication route information t4, and generates the differential route information t7, which indicates a node at which route setting has been changed as a difference. The differential route information t7 includes the identifier of a service in which this route setting is performed, and is generated for each service. The setting unit 13 sets a route for each node based on the differential route information t7. Upon completion of the route setting, the setting unit 13 updates the communication route information t4 with the differential route information t7. Also, the calculation unit 12 updates the shortest route information t3 with the differential route information t7 (or with the shortest route renewal information t6).

Note that a service in which there is no difference when the configuration of the communication network is changed, or a service other than a low latency service is not subjected to the route setting performed by the setting unit 13 based on the differential route information t7. In other words, no differential route information t7 is generated for these services. The computational load is preferably reduced by limiting the targets for which a route is to be reset in this way.

A configuration is also possible in which the maintainer terminal gives an instruction to perform route setting, and the setting unit 13 generates the differential route information t7 in response to this instruction, and performs route setting based on the differential route information t7.

The NW configuration information t1 is information indicating a configuration of the communication network, and includes topological information and delay information. Also, the NW configuration information t1 may be information input from the maintainer terminal operated by a maintainer, rather than being generated by the configuration management unit 11.

The service information t2 is information relating to services provided on the communication network. The service information t2 is generated for each service. The service information t2 includes, for example, information indicating whether or not an object service requires low latency, that is, information indicating whether or not it is required that the allowable value of transmission delay for the object service be less than or equal to a predetermined value. Also, the service information t2 includes, for example, information indicating whether a route is automatically set by the setting unit 13, or a route is input from the maintainer terminal. Also, the service information t2 includes, for example, information indicating the source node and the destination node of a packet for the object service.

The routing control device 1 can use SR (Segment Routing) as routing control for a service that requires low latency (low latency service). On the other hand, the routing control device 1 can perform autonomously-controlled route setting using OSPF as routing control for a service that does not require low latency (normal service).

The shortest route information t3 includes a route that has the shortest transmission delay between nodes and is calculated based on the NW configuration information t1, and the transmission delay value of this route.

The communication route information t4 is information indicating a route set for each node in the communication network.

The possibly changed route information t5 is information indicating possibly changed routes, which are routes that may be changed in accordance with a change in the configuration of the communication network, based on the updated NW configuration information t1 and the generated shortest route information t3.

The shortest route renewal information t6 is information that is generated by the calculation unit 12 performing calculation for the possibly changed routes indicated by the possibly changed route information t5 to obtain routes each having a minimum transmission delay, in accordance with a change in the configuration of the communication network.

The differential route information t7 is information indicating a difference between the shortest route renewal information t6 and the communication route information t4 that is caused when the configuration of the communication network is changed.

<Processing>

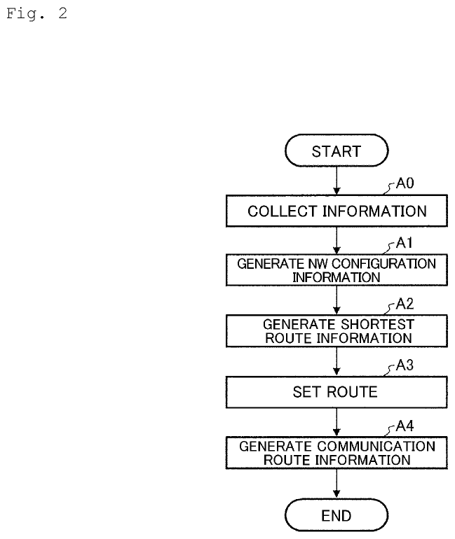

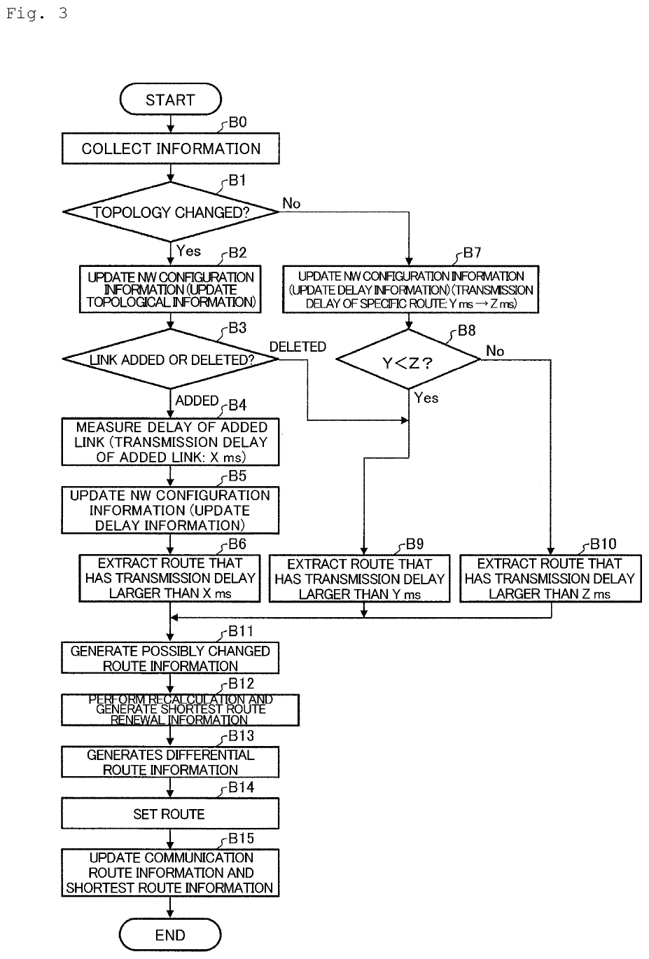

Processing performed by the routing control device 1 will be described. The processing performed by the routing control device 1 can be classified into processing regarding initial route setting (FIG. 2) and processing regarding route setting that is performed when the configuration of the communication network has been changed (FIG. 3). The present processing will be described on the assumption that OSPF and SR are operated on the communication network, and the connection states and delay information of the links can be acquired from the nodes using LLDP, DM, or the like. However, the present processing is applicable without being limited to this assumption. For example, the present processing is applicable to a communication network via which information cannot be acquired, if, for example, a maintainer inputs required information. The following will first describe the processing regarding initial route setting (FIG. 2).

As shown in FIG. 2, the routing control device 1 first collects, using the configuration management unit 11, information from the communication network (step A0). The information collection can be performed by the configuration management unit 11 at regular intervals. Then, the routing control device 1 generates, using the configuration management unit 11, the NW configuration information t1 based on the collected information (step A1). The configuration management unit 11 can also generate the NW configuration information t1 based on an input from the maintainer terminal. In this case, for example, a known transmission distance or a transmission delay value measured in advance is input from the maintainer terminal.

Then, the routing control device 1 generates, using the calculation unit 12, the shortest route information t3 based on the NW configuration information t1 (step A2).

Then, the routing control device 1 performs, using the setting unit 13, route setting for each service based on the service information t2 and the shortest route information t3 (step A3). For example, the routing control device 1 stores in advance the service information t2 input from the maintainer terminal.

Here, the setting unit 13 can perform route setting only for low latency services, out of the services registered in the service information t2. Accordingly, for example, route setting using SR is performed based on the shortest route information t3 for the low latency services, out of the services provided on the communication network. On the other hand, for example, autonomously-controlled route setting using OSPF is performed for the services other than the low latency services. Accordingly, it is possible to reduce the load of route setting.

Note that the setting unit 13 can also perform route setting in response to an input of an instruction to perform route setting from the operator terminal, instead of in response to the generation of the shortest route information t3 (step A2).

Eventually, the routing control device 1 generates, using the setting unit 13, the communication route information t4 indicating routes for which route setting has been performed, out of the routes indicated by the shortest route information t3 (step A4). In the communication route information t4, a route for which route setting has been performed, and a service to be provided using this route (service specified based on the service information t2) are registered in association with each other. If, for example, the autonomously-controlled route setting using OSPF is performed for the services other than the low latency services, a configuration is also possible in which the communication route information t4 is not generated for these services other than the low latency services.

The processing regarding initial route setting (FIG. 2) is thus ended.

With this processing regarding initial route setting (FIG. 2), it is possible to realize routing control that corresponds to the request delay level for each service.

The following will describe the processing regarding route setting that is performed when the configuration of the communication network has been changed (FIG. 3). The processing shown in FIG. 3 is processing that is executed after the processing shown in FIG. 2, and various types of information generated in the processing shown in FIG. 2 are stored in the routing control device 1. As shown in FIG. 3, the routing control device 1 first collects, using the configuration management unit 11, information from the communication network (step B0). The information collection can be performed by the configuration management unit 11 at regular intervals. Also, the collected information may include a failure notification of a link on the communication network.

Then, the routing control device 1 determines, using the configuration management unit 11, whether or not the topology of the communication network has been changed (step B1). If the topology has been changed (Yes in step B1), the routing control device 1 updates, using the configuration management unit 11, the topological information of the NW configuration information t1 based on the change of the topology (step B2). On the other hand, if the topology has not been changed (NO in step B1), this means that there was a change in the transmission delay on the communication network. Accordingly, the routing control device 1 updates, using the configuration management unit 11, the delay information of the NW configuration information t1 based on the change in the transmission delay (step B7). Specifically, it is assumed that the transmission delay value of a specific route is updated from Y ms (where “ms” means millisecond) to Z ms.

Note that transmission delay fluctuates, and thus the determination as to whether or not the transmission delay has been changed is preferably such that the influence of this fluctuation can be reduced. For example, it is preferable to determine that the transmission delay has been changed if an average value of N consecutive measurements relating to transmission delay has been changed from the current transmission delay value by K % or more, and the average value exceeds a threshold M consecutive times. With such determination, it is possible to significantly reduce a shift (variation) in the calculation results of the calculation unit 12 caused due to the temporary fluctuations.

After step B2, the routing control device 1 determines, using the configuration management unit 11, whether or not a link is added or a link is deleted as a change in the topology (step B3). If a link is added (“added” in step B3), the routing control device 1 measures, using the configuration management unit 11, a delay of the added link (step B4). The delay measurement can be performed using ping or DM for example, but is not limited to them. As a result of the delay measurement, it is assumed that the transmission delay value of the added link is X ms. On the other hand, if a link is deleted due to a failure or the like (“deleted” in step B3), the processing moves to step S9, which will be described later. Note that a failure of a link is dealt with as the transmission delay of the link being ∞.

After step B4, the routing control device 1 updates, using the configuration management unit 11, the delay information of the NW configuration information t1 based on the addition of the link (step B5). Then, the routing control device 1 extracts, using the calculation unit 12, a route that has a transmission delay larger than X ms as a possibly changed route from the shortest route information t3 in accordance with the extraction condition [1] (step B6).

On the other hand, after step B7, the routing control device 1 determines, using the calculation unit 12, whether or not the transmission delay updated from Y ms to Z ms satisfies the relationship Y<Z (step B8). If the relationship Y<Z is satisfied (Yes in step B8), that is, if the transmission delay value of the specific route is increased, the routing control device 1 extracts, using the calculation unit 12, a route that has a transmission delay larger than Y ms from the shortest route information t3 in accordance with the extraction condition [2] (step B9). Also, if a link is deleted due to a failure or the like (“deleted” in step B3), the routing control device 1 extracts, using the calculation unit 12, a route that includes the deleted link from the shortest route information t3 in accordance with the extraction condition [2] (step B9).

On the other hand, if the relationship Y<Z is not satisfied (No in step B8), that is, the transmission delay value of the specific route is decreased, the routing control device 1 extracts, using the calculation unit 12, a route that has a transmission delay larger than Z ms from the shortest route information t3 in accordance with the extraction condition [3] (step B10).

Then, the routing control device 1 generates, using the calculation unit 12, the possibly changed route information t5 indicating the route extracted in step B6, B9, or B10 as a possibly changed route (step B11). Then, the routing control device 1 recalculates, using the calculation unit 12, the route serving as the extracted possibly changed route to obtain a route having a minimum transmission delay, and generates the recalculated route as the shortest route renewal information t6 (step B12).

Then, the routing control device 1 compares, using the setting unit 13, the shortest route renewal information t6 with the communication route information t4, and generates the differential route information t7 (step B13). Then, the routing control device 1 performs, using the setting unit 13, route setting based on the differential route information t7 (step B14).

Then, the routing control device 1 updates, using the setting unit 13, the communication route information t4 with the differential route information t7, and updates the shortest route information t3 with the shortest route renewal information t6 (step B15). Accordingly, the content of the differential route information t7 is reflected on the communication route information t4, and the content of the shortest route renewal information t6 is reflected on the shortest route information t3.

With this, the processing regarding route setting performed when the configuration of the communication network has been changed (FIG. 3) is ended.

With the processing regarding route setting that is performed when the configuration of the communication network has been changed (FIG. 3), it is possible to realize routing control in which a transmission delay for a service involving a route change is minimum.

### Specific Example

The following will describe a specific example of the routing control performed by the routing control device 1.

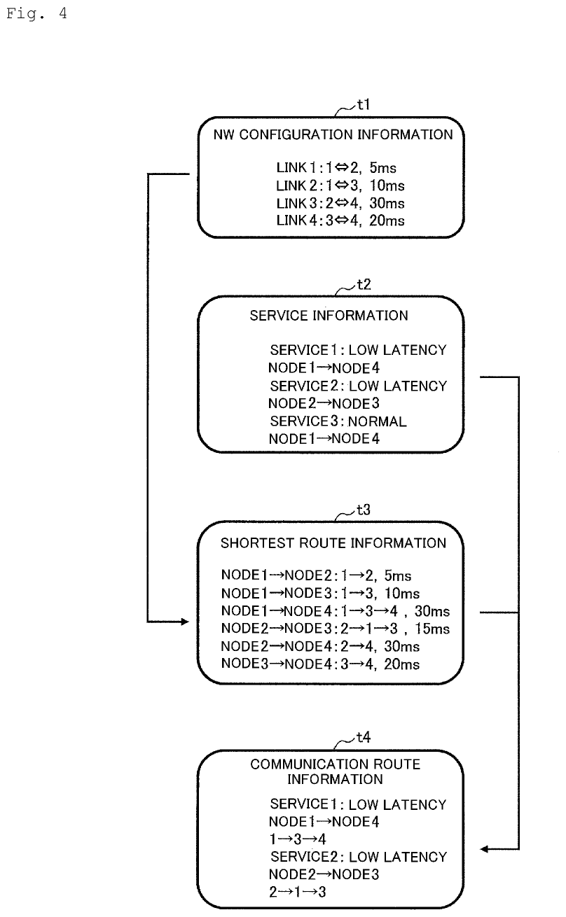

When initial route setting is performed, it is assumed that the NW configuration information t1 stored in the routing control device 1 is as shown in FIG. 4. In the communication network, nodes 1 to 4 with the numbers from “1” to “4” are disposed, and links 1 to 4 are formed. In the illustration of the NW configuration information t1 in FIG. 4, the description “link 1: 1↔2, 5 ms” indicates that the link 1 links the node 1 and the node 2, and the transmission delay is 5 ms.

Also, the description “link 2: 1↔3, 10 ms” indicates that the link 2 links the node 1 and the node 3, and the transmission delay is 10 ms.

Also, the description “link 3: 2↔4, 30 ms” indicates that the link 3 links the node 2 and the node 4, and the transmission delay is 30 ms.

Also, the description “link 4: 3↔4, 20 ms” indicates that the link 4 links the node 3 and the node 4, and the transmission delay is 20 ms.

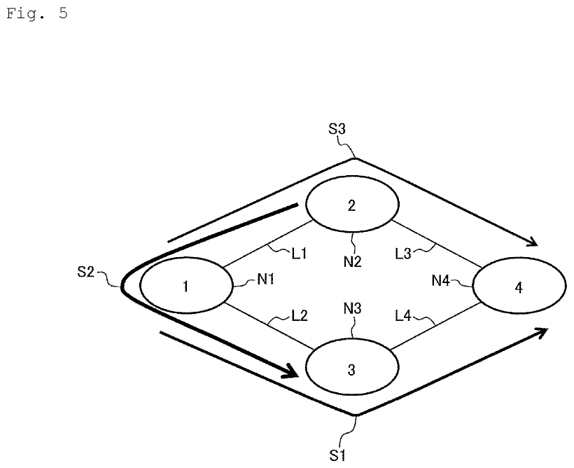

Three types of services S1 to S3 (see FIG. 5) are provided on the communication network.

For ease of description, “node 1” to “node 4” are sometimes denoted as “nodes N1 to N4”. Also, “link 1” to “link 4” are sometimes denoted as “L1 to L4”. Also, the services S1 to S3 are sometimes denoted as “service 1” to “service 3”, respectively.

It is assumed that the service information t2 stored in the routing control device 1 is as shown in FIG. 4. In the illustration of the service information t2 in FIG. 4, the description “service 1: low latency, node 1→node 4” indicates that the service S1 is a service that requires low latency, and the node N1 is the source node of a packet for the service S1, and the node N4 is the destination node of the packet for the service S1.

Also, the description “service 2: low latency, node 2→node 3” indicates that the service S2 is a service that requires low latency, and the node N2 is the source node of a packet for the service S2, and the node N3 is the destination node of the packet for the service S2.

Also, the description “service 3: Normal, node 1→node 4” indicates that the service S3 is a service that does not require low latency, and the node N1 is the source node of a packet for the service S3, and the node N4 is the destination node of the packet for the service S3.

The routing control device 1 generates, using the calculation unit 12, the shortest route information t3 (see step A2 in FIG. 2). In the illustration of the shortest route information t3 in FIG. 4, the description “node 1→node 2: 1→2, 5 ms” indicates that the route that starts at the node N1 and ends at the node N 2, passing through the nodes N1 and N2 in that order, has a transmission delay of 5 ms.

Also, the description “node 1→node 3: 1→3, 10 ms” indicates that the route that starts at the node N1 and ends at the node N3, passing through the nodes N1 and N3 in that order, has a transmission delay of 10 ms.

Also, the description “node 1→node 4: 1→3→4, 30 ms” indicates that the route that starts at the node N1 and ends at the node N4, passing through the nodes N1, N3, and N4 in that order, has a transmission delay of 30 (=10+20) ms.

Also, the description “node 2→node 3: 2→1→3, 15 ms” indicates that the route that starts at the node N2 and ends at the node N3, passing through the nodes N2, N1, and N3 in that order has a transmission delay of 15 (=5+10) ms.

Also, the description “node 2→node 4: 2→4, 30 ms” indicates that the route that starts at the node N2 and ends at the node N4, passing through the nodes N2 and N4 in that order, has a transmission delay of 30 ms.

Also, the description “node 3→node 4: 3→4, 20 ms” indicates that the route that starts at the node N3 and ends at the node N4, passing through the nodes N3 and N4 in that order, has a transmission delay of 20 ms.

The routing control device 1 performs route setting using the setting unit 13, and generates the communication route information t4 as a result of the route setting (see step A4 in FIG. 2). In the illustration of the communication route information t4 in FIG. 4, the description “service 1: low latency, node 1→node 4, 1→3→4” indicates that the route used in communication for the service S1 of the service information t2 is the route that passes through the nodes N1, N3, and N4 in that order.

Also, the description “service 2: low latency, node 2→node 3, 2→1→3” indicates that the route used in communication for the service S2 of the service information t2 is the route that passes through the nodes N2, N1, and N3 in that order.

As shown in FIG. 5, based on the shortest route information t3 indicated by the specific example, initial route setting is performed on the communication network with respect to the services S1 to S3, and routing control is realized. The route (1→3→4) using SR is set for the service S1 that requires low latency, based on the shortest route information t3. Also, the route (2→1→3) using SR is set for the service S2 that requires low latency, based on the shortest route information t3. Also, the autonomously-controlled route (1→2→4) using OSPF is set for the service 3 that is “normal”.

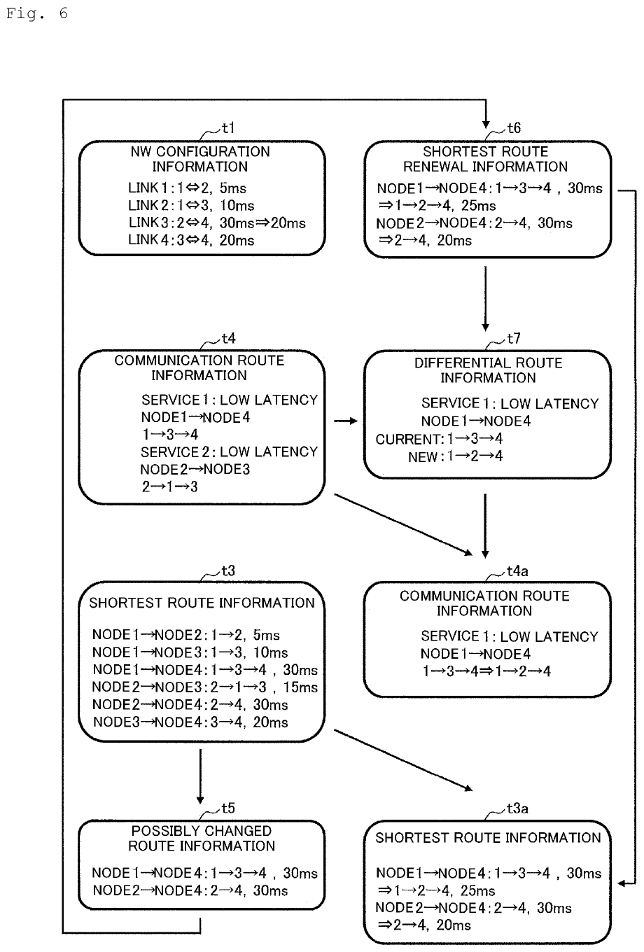

As shown in the NW configuration information t1 in FIG. 6, the transmission delay value of the link 3 is changed from 30 ms to 20 ms as a change in the configuration of the communication network. That is to say, the link 3 is a link that has a decreased transmission delay, and a route including the link 3 is a route that has a decreased transmission delay. Note that the service information t2 is the same as the service information t2 in FIG. 4.

The routing control device 1 extracts, using the calculation unit 12, routes having a transmission delay larger than 20 ms that is the value after the change, based on the shortest route information t3 in FIG. 6 (the same as the shortest route information t3 in FIG. 4) in accordance with the extraction condition [3] (see step B10 in FIG. 3). Also, the routing control device 1 generates, using the calculation unit 12, the possibly changed route information t5 indicating the extracted routes as possibly changed routes (see step B11 in FIG. 3). As a result, as shown in the possibly changed route information t5 in FIG. 6, two routes, namely, the route “node 1→node 4: 1→3→4, 30 ms” and the route “node 2→node 4: 2→4, 30 ms” are extracted.

The routing control device 1 recalculates, using the calculation unit 12, the two extracted routes to obtain routes each having a minimum transmission delay, and generates the shortest route renewal information t6 (see steps B11 and B12 in FIG. 3). As shown in FIG. 6, in the shortest route renewal information t6, the route “node 1→node 4: 1→3→4, 30 ms” is changed to the route “node 1→node 4: 1→2→4, 25 ms”, and the route “node 2→node 4: 2→4, 30 ms” is changed to the route “node 2→node 4: 2→4, 20 ms”.

The routing control device 1 compares, using the setting unit 13, the shortest route renewal information t6 in FIG. 6 with the communication route information t4 in FIG. 4, and generates the differential route information t7 (see step B13 in FIG. 3). In this specific example, the setting unit 13 changes the route “1→3→4” to the route “1→2→4”, based on “node 1→node 4: 1→2→4, 25 ms” of the shortest route renewal information t6 in FIG. 6 and “service 1: low latency, node 1→node 4, 1→3→4” of the communication route information t4 in FIG. 4, and extracts the service S1 that uses the route “1→3→4”, thereby generating the differential route information t7 shown in FIG. 6. In the illustration of differential route information t7 in FIG. 6, the description “service 1: low latency, node 1→node 4, current: 1→3→4, new: 1→2→4” indicates that the route used in communication for the service S1 of the service information t2 is changed from “1→3→4” to “1→2→4”.

The setting unit 13 performs route setting based on the differential route information t7 in FIG. 6 (see step B14 in FIG. 3).

The routing control device 1 updates, using the setting unit 13, the communication route information t4 with the differential route information t7 in FIG. 6 (see step B15 in FIG. 3). As a result, the communication route information t4 in FIG. 4 is rewritten as shown in communication route information t4a in FIG. 6. In the illustration of the communication route information t4a in FIG. 6, the description “service 1: low latency, node 1→node 4, 1→3→4⇒1→2→4” indicates that the route used in communication for the service S1 of the service information t2 is changed from “1→3→4” to “1, 2→4”.

Note that the service S2 that uses a route that does not include the link L3 whose transmission delay has been changed is not extracted into the differential route information t7 in FIG. 6, and thus, for ease of description, the description “service 2: low latency, node 2→node 3, 2→1→3” is omitted in the communication route information t4a in FIG. 6.

Also, the routing control device 1 updates, using the setting unit 13, the shortest route information t3 with shortest route renewal information t6 in FIG. 6 (see step B15 in FIG. 3). As a result, the shortest route information t3 in FIG. 6 (the same as the shortest route information t3 in FIG. 4) is rewritten as shown in shortest route information t3a in FIG. 6.

In the illustration of the shortest route information t3a in FIG. 6, the description “node 1→node 4: 1→3→4, 30 ms⇒1→2→4, 25 ms” indicates that the route that starts at the node N1 and ends at the node N4, passing through the nodes N1, N3, and N4 in that order, is changed to the route that passes through the nodes N1, N2, and N4 in that order, and the transmission delay of the changed route is changed to 25 (=5+20) ms.

Also, in the illustration of the shortest route information t3a in FIG. 6, the description “node 2→node 4: 2→4, 30 ms⇒2→4, 20 ms” indicates that the transmission delay of the route that starts at the node N2 and ends at the node N4, passing through the nodes N2 and N4 in that order, is changed to 20 ms.

Note that, for ease of description, in the shortest route information t3a in FIG. 6, descriptions of other shortest routes are omitted.

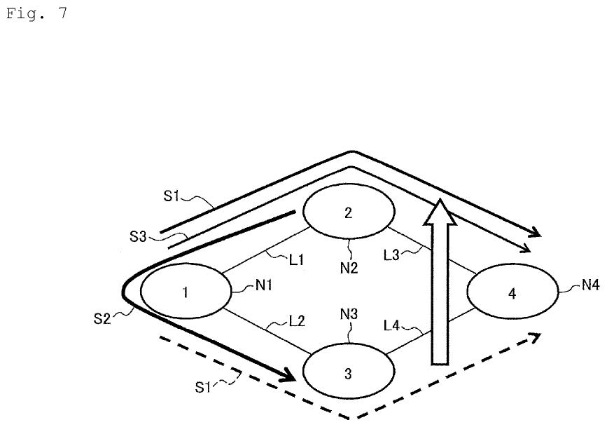

As shown in FIG. 7, based on the updated shortest route information t3a shown in the specific example, route setting when the configuration of the communication network is changed is performed on the communication network, with respect to the services S1 to S3, and routing control is realized. When the transmission delay of the link L3 is reduced, the route (1→3→4) set for the service S1 is reset to the route (1→2→4) whose transmission delay is further reduced.

<Hardware Configuration>

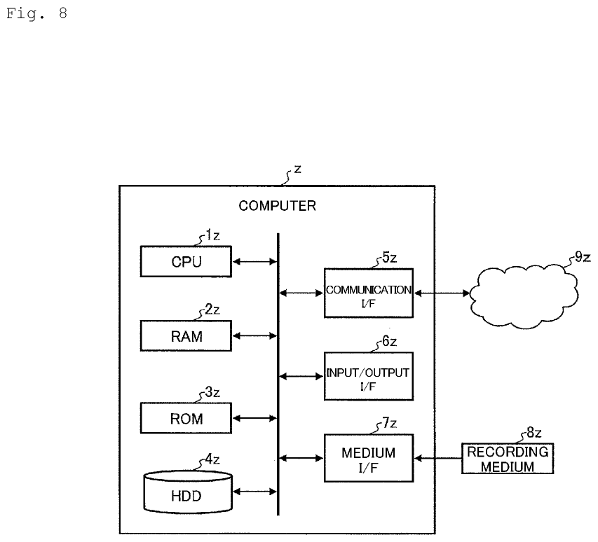

Also, the above-described routing control device 1 is realized by a computer z having a hardware configuration as shown in FIG. 8, for example. The computer z includes a CPU 1z, a RAM 2z, a ROM 3z, an HDD 4z, a communication I/F (interface) 5z, an input/output I/F 6z, and a medium I/F 7z.

The CPU 1z operates based on a program stored in the ROM 3z or the HDD 4z, and controls the constituent components (including the configuration management unit 11, the calculation unit 12, and the setting unit 13). The ROM 3z stores a boot program that is executed by the CPU 1z when the computer z is activated, a program that depends on the hardware of the computer z, and the like.

The HDD 4z stores a program executed by the CPU 1z, data that is used by this program, and the like. The communication I/F 5z receives data from another device via a communication network 9z and transmits the received data to the CPU 1z, and transmits data generated by the CPU 1z to another device via the communication network 9z.

The CPU 1z controls, via the input/output I/F 6z, output devices such as a display and a printer, and input devices such as a keyboard and a mouse. The CPU 1z acquires data from the input devices via the input/output I/F 6z. Also, the CPU 1z outputs generated data to the output devices via the input/output I/F 6z.

The medium I/F 7z reads programs or data stored in a recording medium 8z, and provides the read programs or data to the CPU 1z via the RAM 2z. The CPU 1z loads the programs onto the RAM 2z from the recording medium 8z via the medium I/F 7z, and executes the loaded programs. The recording medium 8z is, for example, an optical recording medium such as, e. g., a DVD (Digital Versatile Disc) or a PD (Phase change rewritable Disk), a magnetooptical recording medium such as a MO (Magneto Optical disk), a tape medium, a magnetic recording medium, a semiconductor memory, or the like.

For example, if the computer z functions as the routing control device 1, the CPU 1z of the computer z executes the programs loaded on the RAM 2z, and thereby realizes the functions of the components. When the programs are executed, data stored in the HDD 4z, and the like are used. The CPU 1z of the computer z reads these programs from the recording medium 8z and executes them, but the CPU 1z may also acquire these programs from another device via the communication network 9z, in another example.

<Effects>

As described above, the routing control device 1 according to the present embodiment is characterized by including: the configuration management unit 11 configured to generate the NW configuration information t1 indicating a configuration of a communication network via which predetermined services are provided; the calculation unit 12 configured to calculate a route in which a transmission delay between nodes disposed in the communication network is minimum based on the NW configuration information t1; and the setting unit 13 configured to set the calculated route for a low latency service, which requires an allowable value of transmission delay to be less than or equal to a predetermined value, out of the services.

With this, it is ensured that a route having the minimum transmission delay is selected as a route for use in the service, and thus it is possible to reduce the transmission delay in the communication network. Also, setting the calculated route is limited to low latency services, which require low latency, out of all of the services on the communication network. At this time, autonomously-controlled route setting, for example, using OSPF with less computational load is performed for the services other than the low latency services. Accordingly, the entire computational load for all of the services is reduced.

Accordingly, it is possible to realize routing control that reduces transmission delays in the communication network, and reduces the computational load.

As a result, the route setting of the present embodiment is applicable even to a case of a large-scale communication network.

Also, the routing control device 1 according to the present embodiment is characterized in that, if the configuration of the communication network is changed, the configuration management unit 11 updates the NW configuration information t1, the calculation unit 12 recalculates, based on the updated NW configuration information t1, any of the calculated routes whose transmission delay is changed due to the change in the configuration, and the setting unit 13 sets the recalculated route for a low latency service.

Accordingly, the routes that require recalculation can be limited, and thus it is possible to reduce the computational load of route setting. Also, the amount of processing of the route setting can be reduced, and thus it is possible to reduce time required to follow the change in the configuration of the communication network.

Also, the routing control device 1 according to the present embodiment is characterized in that the configuration management unit 11 collects information from the communication network at regular intervals, and updates the NW configuration information t1.

Accordingly, it is possible to follow a change in the configuration of a network in real time, and reliably select a route having the minimum transmission delay based on the latest NW configuration information t1. As a result, it is possible to significantly reduce the likelihood that a service is adversely affected.

<Other Configurations>

In the present embodiment, services are classified into two types, namely, “low latency” and “normal”, and the shortest route is set for a “low latency” service. However, a plurality of levels for transmission delays may also be provided by preparing a plurality of types of allowable values of transmission delay values. In other words, the services may also be classified into three or more types based on the transmission delay levels. As a result, not only the shortest route can be set as a set route but also a plurality of types of routes that have different transmission delay levels can be set, and it is possible to realize routing control based on the plurality of types of transmission delay levels. Accordingly, a price system that corresponds to the transmission delay level can be prepared, and a service that matches a user's demand can be provided. For example, a service that has a relatively large delay but is relatively inexpensive can be provided.

Also, delay conditions using a plurality of types of allowable values can be created, and if this delay condition is selected, the route having the largest delay can be selected from routes that satisfy the selected delay conditions. If there is no route that satisfies the selected delay condition, the route having the smallest delay can be selected. Also, the selected route may also be set in response to a setting instruction given from the maintainer terminal.

Instead of the routing control device 1 including the configuration management unit 11, the calculation unit 12, and the setting unit 13, a configuration is also possible in which a network system including a plurality of computing machineries that can communicate with each other is prepared, and the network system includes the configuration management unit 11, the calculation unit 12, and the setting unit 13. In this case, the plurality of computing machineries may include at least any of the configuration management unit 11, the calculation unit 12, and the setting unit 13, and as a result, the network system may include the configuration management unit 11, the calculation unit 12, and the setting unit 13.

It is also possible to realize a technique obtained by combining various techniques described in the present embodiment with each other.

### REFERENCE SIGNS LIST

1 Routing control device
11 Configuration management unit
12 Calculation unit
13 Setting unit
t1 NW configuration information
t2 Service information
t3 Shortest route information
t4 Communication route information
t5 Possibly changed route information
t6 Shortest route renewal information
t7 Differential route information

1. A routing control device comprising:
a configuration management unit comprising one or more computers and configured to generate network (NW) configuration information that indicates a configuration of a communication network via which predetermined services are provided;
a calculation unit comprising the one or more computers and configured to calculate, based on the NW configuration information, routes that have a minimum transmission delay between nodes disposed in the communication network; and
a setting unit comprising the one or more computers and configured to set a calculated route for a low latency service that requires an allowable value of transmission delay to be less than or equal to a predetermined value, out of the predetermined services.

2. The routing control device according to claim 1, wherein
if the configuration of the communication network is changed, the configuration management unit updates the NW configuration information,
the calculation unit recalculates, based on the updated NW configuration information, any of the calculated routes whose transmission delay is changed due to the change in the configuration, and
the setting unit sets the recalculated route for the corresponding low latency service.

3. The routing control device according to claim 2, wherein
the configuration management unit collects information from the communication network at regular intervals, and updates the NW configuration information.

4. A routing control method comprising steps, performed by a routing control device, comprising:
generating NW configuration information that indicates a configuration of a communication network via which predetermined services are provided;
calculating, based on the NW configuration information, routes that have a minimum transmission delay between nodes disposed in the communication network; and
setting a calculated route for a low latency service that requires an allowable value of transmission delay to be less than or equal to a predetermined value, out of the services.

5. The routing control method according to claim 4, wherein,
if the configuration of the communication network is changed, the method further comprises the steps, performed by the routing control device, of:
updating the NW configuration information;
recalculating, based on the updated NW configuration information, any of the calculated routes whose transmission delay is changed due to the change in the configuration; and
setting the recalculated route for the corresponding low latency service.

6. The routing control method according to claim 5, wherein
in the step of updating the NW configuration information, the routing control device collects information from the communication network at regular intervals, and updates the NW configuration information.

7. A program stored in a computer-readable medium and executable for causing a computer to execute the routing control method according to claim 4.

8. A network system comprising:
a configuration management unit comprising one or more computers and configured to generate network (NW) configuration information that indicates a configuration of a communication network via which predetermined services are provided;
a calculation unit comprising the one or more computers and configured to calculate, based on the NW configuration information, routes that have a minimum transmission delay between nodes disposed in the communication network; and
a setting unit comprising the one or more computers and configured to set a calculated route for a low latency service that requires an allowable value of transmission delay to be less than or equal to a predetermined value, out of the predetermined services.
